(19) United States
(12) Patent Application Publication
(10) Pub. No.: US 2007/0107309 A1
(43) Pub. Date: May 17, 2007

(54) Multipanel sliding doors

(76) Inventor: Piero Molteni, Milan (IT)

Correspondence Address: WENDEROTH, LIND & PONACK, L.L.P., 2033 K STREET N. W., SUITE 800, WASHINGTON, DC, 20006-1021, US

(21) Appl. No.: 10/583,322

(22) PCT Filed: Apr. 12, 2005
(86) PCT No.: PCT/IT05/00203

§ 371 Date: Jun. 16, 2006

(30) Foreign Application Priority Data
Apr. 15, 2004 (IT) MI 2004 U 000170

(51) Int. Cl. E05D 15/26

(52) U.S. Cl. 49/125

(57) ABSTRACT

The multipanel sliding door comprises at least two panels which are supported for travel in substantially parallel planes along runners, and is characterised in that a rack and wheelwork arrangement is provided for the movement of the door panels.

### TECHNICAL FIELD

The present invention relates to multipanel sliding doors, such as those used for providing a controlled access to an entranceway or the like in a wall or similar building structure.

### BACKGROUND ART

Multipanel sliding doors of the kind mentioned above generally comprise two or more panels which are supported for travel in substantially parallel planes along runners. In a known arrangement, the door panels are caused to move in a stepwise manner, i.e. the door panels are interconnected to each other in such a way that, in closing the door, a first panel is caused to move in one direction and, once it has covered a certain distance, said first panel engages a second panel and pulls it along in its movement. The second panel, in turn, after having covered a certain distance, engages a third panel, and so on until all the panels of the door are drawn out to the full extension. In opening the door, the panels are moved in the same sequence as described above, but in an opposite direction.

An arrangement of this kind has at least two significant disadvantages in operation. The first is concerned with the noise produced by the knocking of a moving panel against a stationary panel, when the former is moved into engagement with the latter.

A second disadvantage is that opening and closing of the door is achieved through a number of steps each requiring a pulling or pushing effort which increases with the number of panels which are operated.

### DISCLOSURE OF INVENTION

The present invention is directed to an improvement to a multipanel sliding door of the kind mentioned above so that said disadvantages are avoided and the operation of the door panels is synchronised.

The invention achieves this object by providing a multipanel sliding door comprising at least two panels which are supported for travel in substantially parallel planes along runners, characterised in that a rack and wheelwork arrangement is provided for the movement of the door panels.

### BRIEF DESCRIPTION OF DRAWINGS

The invention will now be elucidated in connection with the figures of the accompanying drawings, wherein:

FIG. 1 is a perspective partial view of a first preferred embodiment of the multipanel sliding door according to the present invention;

FIG. 2 is a side partial view of the multipanel sliding door of FIG. 1;

FIG. 3 is a perspective partial view of a second preferred embodiment of the multipanel sliding door according to the present invention;

FIG. 4 is an exploded perspective partial view of the multipanel sliding door of FIG. 3;

FIG. 5 is a perspective partial view of a third preferred embodiment of the multipanel sliding door according to the present invention; and

FIG. 6 is an exploded perspective partial view of the multipanel sliding door of FIG. 5.

### BEST MODE FOR CARRYING OUT THE INVENTION

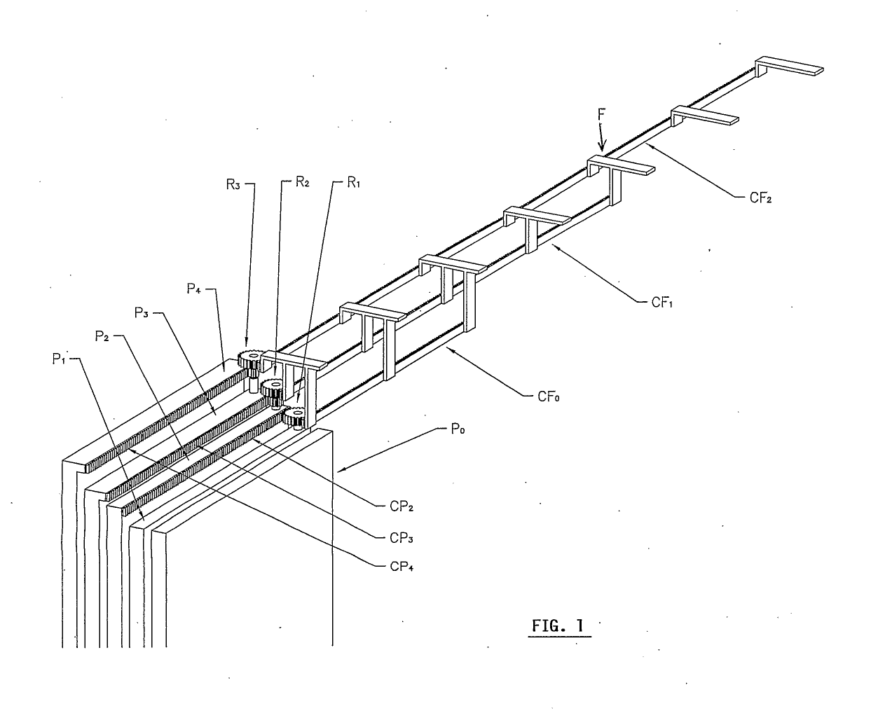

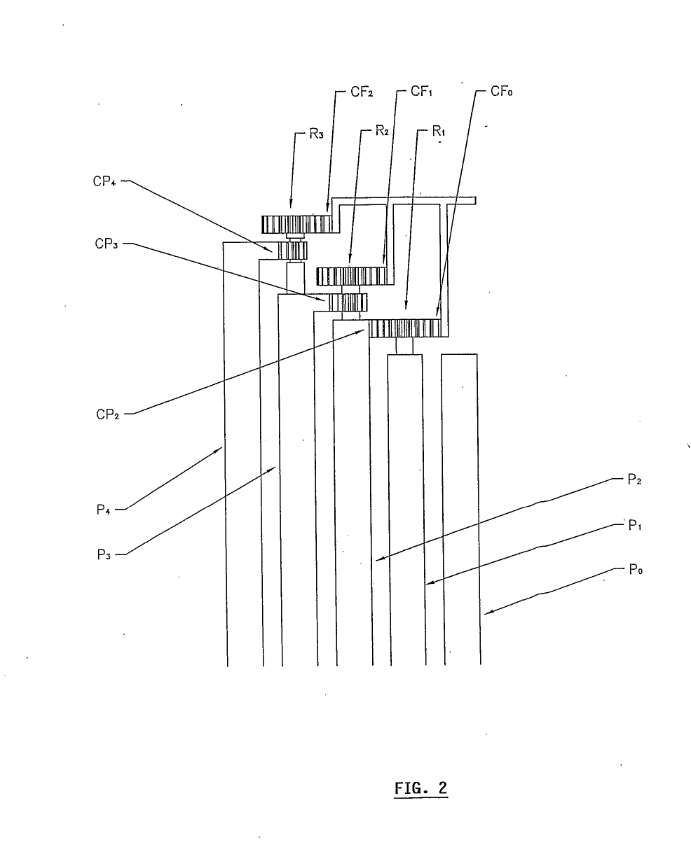

Referring to FIGS. 1 and 2 of the drawings, a first embodiment of the multipanel sliding door is comprised of a door header F extending parallel to a door runner not shown, which may be of any suitable kind known in the art, and a set of adjacent panels P={P₀, P₁, P₂, P₃, P₄}, whereof a panel P₀ is stationary and the remaining panels P₁-P₄ are supported for travel in planes substantially parallel thereto. Panels P₀-P₄ have preferably equal width L.

For the movement of the panels an arrangement is provided which is comprised of a first set of racks CF={CF₀, CF₁, CF₂} which are fixedly supported by door header F, a second set of racks CP={CP₂, CP₃, CP₄} which are attached to or formed unitarily with panels P₂, P₃, P₄, respectively, and a set of wheelworks R={R₁, R₂, R₃} which are rotatably mounted on panels P₁, P₂, P₃, respectively, and are designed to mesh together with first CF and second CP set of racks.

The length of racks CF₀, CF₁, CF₂ is equal to L, 2L, 3L, respectively, whereas the length of racks CP₂, CP₃, CP₄ is equal to L.

Set of wheelworks R includes wheelwork R₁ formed of a single toothed wheel which is meshed together with rack CF₀ of set CF and with rack CP₂ of set CP, and wheelworks R₂, R₃ each formed of two coaxial and co-rotating toothed wheels, whereof a first larger diameter toothed wheel is meshed together with rack CF₁, CF₂, respectively, of set CF and a second smaller diameter toothed wheel is meshed together with rack CP₃, CP₄, respectively, of set CP.

The selection of a suitable ratio of the diameters of the toothed wheels forming wheelworks of set R is made under the criterion of providing a kinematical link whereby the displacement of the k-th panel Pₖ is in any time k times the displacement of panel P₁.

In fact, in a multipanel sliding door as described above, comprising a set of panels P having each a width L, the door shall reach its full extension when panel P₁ has travelled a distance L, panel P₂ a distance 2L, panel P₃ a distance 3L, with respect to fixed panel P₀.

This may be formulated explicitly and generally by the rule that the displacement sₖ of the k-th panel Pₖ is proportional to k, where subscript k≧1.

For determining in a general way the ratio of the diameters of the toothed wheels forming the k-th wheelwork Rₖ of set R, one may note that when panel Pₖ covers a distance sₖ, panel Pₖ₊₁ which is adjacent thereto overtakes the former by a distance which is equal to:
sₖ₊₁−sₖ=πnₖdₖ (1)
where nₖ is the rotational speed of wheelwork Rₖ, and dₖ is the diameter of the smaller toothed wheel of wheelwork Rₖ.

The rotational speed of the k-th wheelwork Rₖ of set R is given by the relationship:
nₖ=sₖ/(πDₖ) (2)
where Dₖ is the diameter of the larger toothed wheel of wheelwork Rₖ.

Substituting eq. 2 for nₖ in eq. 1 gives:
sₖ₊₁−sₖ=πsₖdₖ/Dₖ (3)

Under the general rule that the displacement sₖ of the k-th panel Pₖ, where subscript k≧1, is proportional to k, eventually the following relationship is obtained:
Dₖ/dₖ=k (4)

Thus, by applying eq. 4 in the case of the multipanel sliding door shown in FIGS. 1 and 2, one obtains the following ratios:

| | Ratio of wheel diameters |
|---|---|
| Wheelwork Rₖ | Dₖ/dₖ |
| R₁ | 1⁽*⁾ |
| R₂ | 2 |
| R₃ | 3 |

⁽*⁾Clearly, this corresponds to having a single wheel of diameter D₁.

By using the above ratios in the design of wheelworks Rₖ of set R, the displacement sₖ of the k-th panel Pₖ is proportional to k, where subscript k≧1, and the extension of the multipanel sliding door may range from L to (number of panels +1)×L, L being the width of each panel as mentioned above.

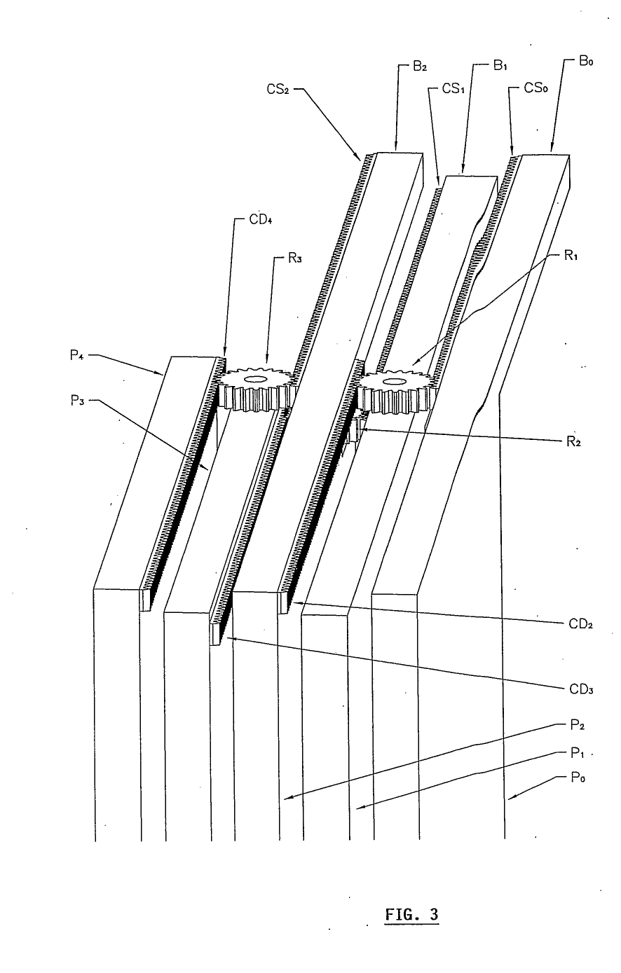

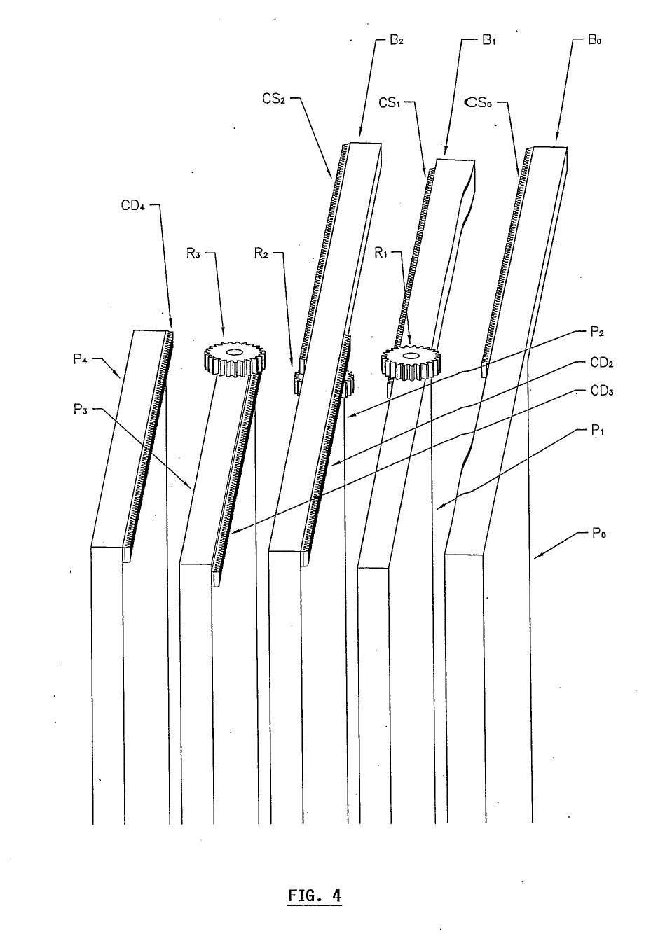

Referring to FIGS. 3 and 4 of the drawings, a second embodiment of the multipanel sliding door is comprised of a set of adjacent panels P={P₀, P₁, P₂, P₃, P₄}, whereof a panel P₀ is stationary and the remaining panels P₁-P₄ are supported for travel in planes substantially parallel thereto. Panels P₀-P₄ have preferably equal width L. Panels P₀, P₁, P₂ have an extension arm B₀, B₁, B₂, respectively, at their top which extends in the direction of travel of the panels.

For the movement of the panels an arrangement is provided which is comprised of a first set of racks CS={CS₀, CS₁, CS₂} which are attached to or formed unitarily with the extension arms B₀, B₁, B₂ of panels P₀, P₁, P₂, respectively, a second set of racks CD={CD₂, CD₃, CD₄} which are attached to or formed unitarily with panels P₂, P₃, P₄, respectively, and a set of wheelworks R={R₁, R₂, R₃} which are rotatably mounted on panels P₁, P₂, P₃, respectively, and are designed to mesh together with first CS and second CD set of racks.

Racks CS₀, CS₁, CS₂ are facing towards panels P₁, P₂, P₃, respectively, whereas racks CD₂, CD₃, CD₄ are facing towards panels P₁, P₂, P₃, respectively.

Also in this second embodiment it is desirable that a kinematical link be provided whereby the displacement of the k-th panel Pₖ is in any time k times the displacement of panel P₁.

In the second embodiment, one may observe that when panel Pₖ travels a distance sₖ, panel Pₖ₊₁ adjacent thereto overtakes the former by a distance which is equal to:
sₖ₊₁−sₖ=πnₖDₖ (5)
where nₖ is the rotational speed of wheelwork Rₖ, and Dₖ is the diameter of the toothed wheel of wheelwork Rₖ.

The rotational speed of the k-th wheelwork Rₖ of set R is given by the relationship:
nₖ=(sₖ−sₖ₋₁)/(πDₖ) (6)

Substituting eq. 6 for nₖ in eq. 5 gives:
sₖ₊₁−sₖ=sₖ−sₖ₋₁ (7)
and thus:
sₖ₊₁=2sₖ−sₖ₋₁ (8)
where subscript k≧1.

Considering that s₀=0 because panel P₀ is stationary, from eq. 8 one obtains:

| Panel Pₖ₊₁ | Displacement sₖ₊₁ |
|---|---|
| P₂ | s₂ = 2s₁ |
| P₃ | s₃ = 2s₂ − s₁ = 3s₁ |
| P₄ | s₄ = 2s₃ − s₂ = 4s₁ |

Thus, also with the arrangement of the second embodiment the desired kinematical link is obtained, i.e. the displacement of the k-th panel Pₖ is in any time k times the displacement of panel P₁.

Both first and second embodiments include an end panel P₀ which is stationary and the movement of the remaining panels P₁-P₄ occurs always in a certain given direction with respect to the stationary panel.

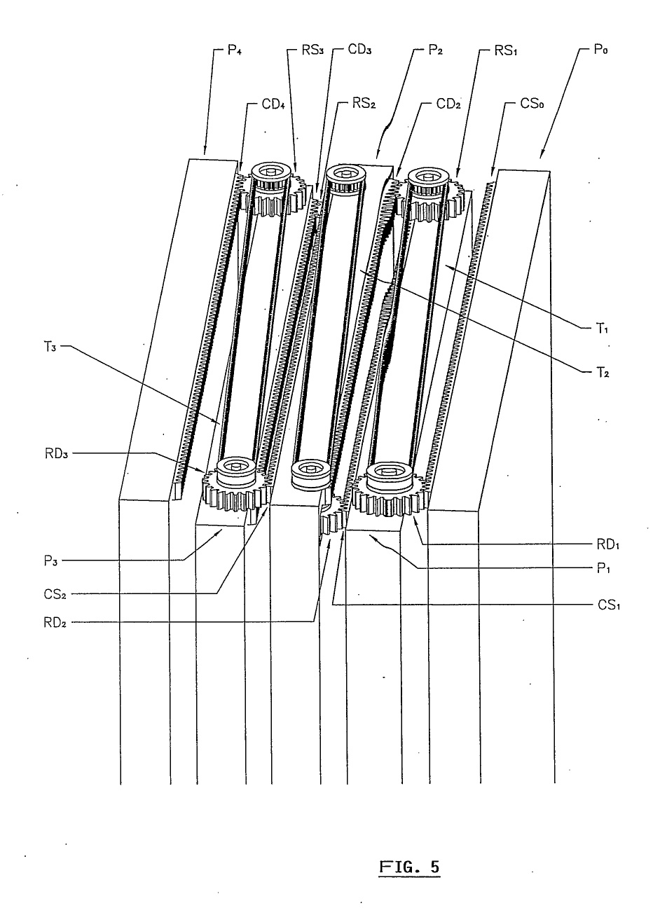

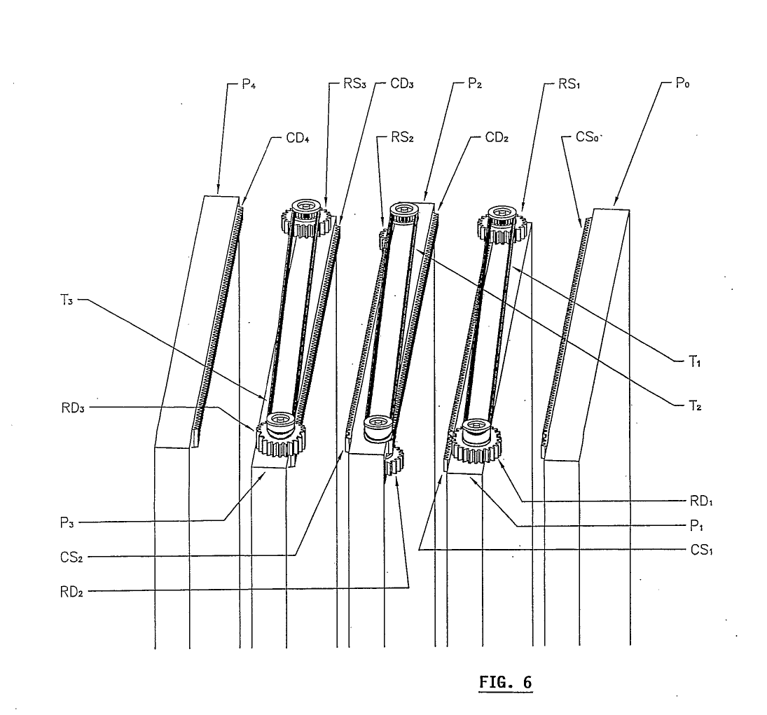

This limitation can be overcome with the following third embodiment illustrated in FIGS. 5 and 6, wherein all the panels are supported for travel in substantially parallel planes and the multipanel sliding door can be extended in either direction desired, depending on which end panel is kept in a fixed position.

Referring to FIGS. 5 and 6 of the drawings, the third embodiment of the multipanel sliding door is comprised of a set of adjacent panels P={P₀, P₁, P₂, P₃, P₄}, which are supported for travel in substantially parallel planes and have preferably equal width L.

For the movement of the panels an arrangement is provided which includes a first set of racks CS={CS₀, CS₁, CS₂} which are attached to or formed unitarily with panels P₀, P₁, P₂, a second set of racks CD={CD₂, CD₃, CD₄} which are attached to or formed unitarily with panels P₂, P₃, P₄, respectively, and a set of pairs of wheelworks R={(RS₁, RD₁), (RS₂, RD₂), (RS₃, RD₃)} which are rotatably mounted on panels P₁, P₂, P₃, respectively, and are designed to mesh together with first CS and second CD set of racks.

Racks CS₀, CS₁, CS₂ are facing towards panels P₁, P₂, P₃, respectively, whereas racks CD₂, CD₃, CD₄ are facing towards panels P₁, P₂, P₃, respectively.

Each pair of wheelworks (RS₁, RD₁), (RS₂, RD₂), (RS₃, RD₃) includes a first wheelwork RS₁, RS₂, RS₃ designed to mesh together with rack CD₂, CD₃, CD₄, respectively, of second set of racks CD and a second wheelwork RD₁, RD₂, RD₃ designed to mesh with rack CS₀, CS₁, CS₂, respectively, of first set of racks CS.

The first and second wheelwork of each pair of wheelworks (RS₁, RD₁), (RS₂, RD₂), (RS₃, RD₃) are interlinked with one another by a transmission T₁, T₂, T₃, respectively, in order to rotate at the same rotational speed. In the embodiment shown, transmission T₁, T₂, T₃ is formed of an endless belt.

In order to understand the operation of the third embodiment, one may consider for instance panel P₀ as a stationary panel and the remaining panels P₁-P₄ supported for travel in planes substantially parallel thereto.

Also in this third embodiment it is desirable that a kinematical link be provided whereby the displacement of the k-th panel Pₖ is in any time k times the displacement of panel P₁.

In the third embodiment, one may observe that when panel Pₖ travels a distance sₖ, panel Pₖ₊₁ adjacent thereto overtakes the former by a distance which is equal to:
sₖ₊₁−sₖ=πnₖDₖ (9)
where nₖ is the rotational speed of wheelwork Rₖ, and Dₖ is the diameter of the toothed wheel of wheelwork Rₖ.

The rotational speed of the k-th wheelwork Rₖ of set R is given by the relationship:
nₖ=(sₖ−sₖ₋₁)/(πDₖ) (10)

Substituting eq. 10 for nₖ in eq. 9 gives:
sₖ₊₁−sₖ=sₖ−sₖ₋₁ (11)
and thus:
sₖ₊₁=2sₖ−sₖ₋₁ (12)
where subscript k≧1.

Considering that s₀=0 because panel P₀ is assumed to be the stationary end panel, from eq. 12 one obtains:

| Panel Pₖ₊₁ | Displacement sₖ₊₁ |
|---|---|
| P₂ | s₂ = 2s₁ |
| P₃ | s₃ = 2s₂ − s₁ = 3s₁ |
| P₄ | s₄ = 2s₃ − s₂ = 4s₁ |

Thus, also with the arrangement of the third embodiment the desired kinematical link is obtained, i.e. the displacement of the k-th panel Pₖ is in any time k times the displacement of panel P₁ assuming that P₀ designates the end panel which is kept in a fixed position.

1. A multipanel sliding door comprising at least two panels which are supported for travel in substantially parallel planes along runners, characterised in that a rack and wheelwork arrangement is provided for the movement of the door panels.

2. The multipanel sliding door of claim 1, characterised in that it is comprised of:
a door header F extending parallel to the door runners,
a set of n adjacent panels P={P₀, P₁, . . . , Pₙ₋₁}, whereof a panel P₀ is stationary and the remaining n−1 panels P₁, P₂, . . . , Pₙ₋₁ are supported for travel in planes substantially parallel thereto, the n panels P₀, P₁, . . . , Pₙ₋₁ of set P having equal width L,
a first set of n−2 racks CF={CF₀, CF₁, . . . , CFₙ₋₃} which are fixedly supported by door header F, the length of racks CF₀, CF₁, . . . , CFₙ₋₃ of set CF being equal to L, 2L, . . . , (n−2)L, respectively,
a second set of n−2 racks CP={CP₂, CP₃, . . . , CPₙ₋₁} which are attached to or formed unitarily with panels P₂, P₃, . . . , Pₙ₋₁, respectively, of set P, the length of racks CP₂, CP₃, . . . , CPₙ₋₁ of set CP being equal to L,
a set of n−2 wheelworks R={R₁, R₂, . . . , Rₙ₋₂} which are rotatably mounted on n−2 panels P₁, P₂, . . . , Pₙ₋₂, respectively, of set P and are designed to mesh together with first CF and second CP set of racks,
set R including:
a wheelwork R₁ formed of a single toothed wheel which is meshed together with rack CF₀ of set CF and with rack CP₂ of set CP, and
n−3 wheelworks R₂, R₃, . . . , Rₙ₋₂ each formed of two coaxial and co-rotating toothed wheels, whereof a first larger diameter toothed wheel is meshed together with rack CF₁, CF₂, . . . , CFₙ₋₃, respectively, of set CF and a second smaller diameter toothed wheel is meshed together with rack CP₃, CP₄, . . . , CPₙ₋₁ of set CP, wherein the ratio of the diameter Dₖ of the larger toothed wheel to the diameter dₖ of the smaller toothed wheel of k-th wheelwork Rₖ is equal to k=2, 3, . . ., n−2.

3. The multipanel sliding door of claim 1 characterised in that it is comprised of:
a set of n adjacent panels P={P₀, P₁, . . . , Pₙ₋₁}, whereof a panel P₀ is stationary and the remaining n−1 panels P₁, P₂, . . . , Pₙ₋₁ are supported for travel in planes substantially parallel thereto, the n panels P₀, P₁, . . . , Pₙ₋₁ of set P having equal width L, and n−2 panels P₀, P₁, . . . , Pₙ₋₃ of set P having an extension arm B₀, B₁, . . . , Bₙ₋₃, respectively, at their top extending in the direction of travel of the panels,
a first set of n−2 racks CS={CS₀, CS₁, . . . , CSₙ₋₃} which are attached to or formed unitarily with extension arms B₀, B₁, . . . , Bₙ₋₃, of n−2 panels P₀, P₁, . . . , Pₙ₋₃, respectively, of set P,
a second set of n−2 racks CD={CD₂, CD₃, . . . , CDₙ₋₁} which are attached to or formed unitarily with panels P₂, P₃, . . . , Pₙ₋₁, respectively, of set P,
a set of n−2 wheelworks R={R₁, R₂, . . . , Rₙ₋₂} which are rotatably mounted on n−2 panels P₁, P₂, . . . , Pₙ₋₂, respectively, of set P and are designed to mesh together with first CS and second CD set of racks.

4. The multipanel sliding door of claim 1, characterised in that it is comprised of:
a set of n adjacent panels P={P₀, P₁, . . . , Pₙ₋₁}, which are supported for travel in substantially parallel planes and have equal width L,
a first set of n−2 racks CS={CS₀, CS₁, . . . , CSₙ₋₃} which are attached to or formed unitarily with n−2 panels P₀, P₁, . . . , Pₙ₋₃, respectively, of set P,
a second set of n−2 racks CD={CD₂, CD₃, . . . , CD₋₁} which are attached to or formed unitarily with n−2 panels P₂, P₃, . . . , Pₙ₋₁, respectively, of set P,
a set of n−2 pairs of wheelworks R={(RS₁, RD₁,), (RS₂, RD₂), . . . , (RSₙ₋₂, RDₙ₋₂)} which are rotatably mounted on n−2 panels P₁, P₂, . . . , Pₙ₋₁, respectively, each pair of wheelworks (RS₁, RD₁), (RS₂, RD₂), . . . , (RS₋₂, RDₙ₋₂) including a first wheelwork RS₁, RS₂, . . . , RSₙ₋₂ designed to mesh together with rack CD₂, CD₃, . . . , CDₙ₋₁, respectively, of second set of racks CD and a second wheelwork RD₁, RD₂, . . . , RDₙ₋₂ designed to mesh with rack CS₀, CS₁, . . . , CSₙ₋₃, respectively, of first set of racks CS, the first and second wheelwork of each pair of wheelworks (RS₁, RD₁), (RS₂, RD₂), . . . , (RSₙ₋₂, RDₙ₋₂) of set R being interlinked with one another by a transmission T₁, T₂, . . . , Tₙ₋₂, respectively, in order to rotate at the same rotational speed.
